(19) United States
(12) Patent Application Publication
(10) Pub. No.: US 2007/0226250 A1
(43) Pub. Date: Sep. 27, 2007

(54) Patent Figure Drafting Tool

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,459

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 7/00

(52) U.S. Cl. 707/102

(57) ABSTRACT

A patent figure drafting tool is described. The patent figure drafting tool includes a database of drawings which can be used alone, or in combination with each other or other drawings, to create patent figures. The tool may further include exemplary descriptions of the drawings, which may be automatically included in a draft patent application. The tool may further include an auto numbering program configured to auto number drawings and/or descriptions of the drawings.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to various embodiments, the present disclosure provides a patent figure drafting tool allows a figure to be drafted and/or modified and attached to one or more patent applications so that it can be electronically filed with the patent office. The system provides standard figures, diagrams, images, schematics, templates, fonts, shapes, and icons of components that may be certified by the patent office or other governing body to ensure that all images created with the tool are patent office compliant.

The disclosed system permits end users, for example, patent applicants, patent attorneys, draftspersons and/or authorized end users to create and/or maintain a list or database of figures, diagrams, images, schematics, templates, fonts, shapes and icons of components that are acceptable to the patent office or owner of the system, e.g., private company, e.g., design services firm or patent law firm.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application,—includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

Patent Application—includes an invention disclosure that has been filed with a registration entity such as the USPTO

Patent Application Drafting Tool—includes a web based software program that assists in the drafting and filing of patent applications with a registration entity such as the USPTO. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference.

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims. Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, the present disclosure provides a patent figure drafting tool. In an embodiment, any end user may submit one or more or any part of one or more figures, templates, diagrams, images, schematics, fonts, shapes, icons, etc. for subsequent review and approval by any authorized person, e.g., patent office examiners or others that are assigned or dedicated to such purpose. In this fashion, over time, a large data repository of figures, graphics, diagrams, images, schematics, icons, audio, video or any other figures or attachments may be submitted and, once approved, made available for future use or modification.

When using a patent drafting system, which may be enhanced to permit the addition or use of plug-ins, end users may, while drafting or subsequently modifying an application, add one or more notes or diagram. Exemplary methods to provide attachment of notes into documents and/or associate notes with documents, or words, or other data are disclosed in U.S. patent application Ser. Nos. 11/690,095 “Facilitating Certified Prior Art Note Taking and Method for Using Same,” filed Mar. 22, 2007; ______ (Attorney docket No. 3307102) entitled “Note Overlay System,” filed Apr. 6, 2007; and ______ (Attorney docket No. 3307103) entitled “Document Examiner Comment System,” filed Apr. 6, 2007; each of which is incorporated herein by reference. which are incorporated by reference. In various embodiments, notes may be used for any desired purposes, for example, adding explanations, background materials, purpose, use information, features, restrictions or limitations, supplemental materials, hyperlinks to access any or all of the above, to provide one or more links between certain figures, diagrams, schematics, images, etc., to provide linkes between related materials, e.g., secondary or other points of view of the same materials, and/or to provide further details, e.g., levels of detail, commentary or review by examiners and/or applicant's and/or applicant's attorneys and/or draftsperson and/or third parties, or any other interested individuals. Furthermore, such notes may include advertisements for the sale of goods and services, e.g., drafting services by the person(s) or firm that created or modified the figures, diagrams, etc., and/or advertisements or offers to license the invention disclosed or depicted in such diagrams, figures, etc., and/or ads for legal services, or any other advertising, offers for sale or purchase or license or sub-license. Notes may further provide other general or specific commentary and/or other hyperlinks, e.g., to provide support to run an application that demonstrates the invention. For example, a diagram of a motor might have a hyperlink to a program that runs a visual simulation, cartoon, video or other virtual or actual demonstration of a prototype, mockup or actually device, which could prove useful to anyone that desires to understand how the disclosed invention works or how various components interact.

As an end user adds or otherwise associates one or more notes, diagrams, or figures to a patent application, disclosure, and/or other document(s), the system may permit the end user to determine the figure number(s) to associate with such notes, diagrams or figures. In certain embodiments, end users simply indicate the figure numbers they wish to use. Additionally or alternatively, the system may either recommend a figure number and/or automatically insert the next appropriate figure number(s), which may or may not be modifiable after insertion. The system may determine the next or appropriate figure number(s) using any applicable means, including, for example, incrementing the figure numbers with each subsequent use, starting at any number, e.g., one, or another starting point by examining the current figure number(s), if any, and adding one or some other increment to the last figure number as applicable and/or by retrieving a figure number from a database constructed for such purposes and incrementing such retrieved number by one or some other positive or negative whole or fractional number or multiplier. In this way, the system may recommend figure numbers and/or may insert such numbers automatically. In cases where the system inserts such figure numbers, such numbers may or may not be modifiable. Whether or not such numbers are modifiable may be determined by any applicable means, including, for example, by the designer of the system or figure assignment numbering software application or plug-in and/or by the USPTO or other governing body, and/or by the end user or owner of the server or application, e.g., a company may establish a policy that such figures are to be modifiable or that they may not be modifiable or such modifications may have imposed limitations, or that they may only be modified by certain end users, e.g., a patent attorney or patent examiner, etc. This system may be implemented to both simplify figure numbering assignments and/or to ensure that figure numbers are unique to each figure.

In certain embodiments, end users may associate a short and/or long description with any note, diagram, figure or figure number. Such descriptions may be generic and/or end users may submit generic and/or specific entries. Attachment of such descriptions and/or notes may be accomplished via any applicable means. In certain embodiments, end users may submit generic or standard diagrams and/or descriptions. For example, the USPTO may provide a generic acceptable diagram and short and/or long descriptions for a CPU. Subsequently, end users may submit proposed changes or additions to such description and/or they may submit one or more alternative or substitution descriptions, diagrams, etc. Such proposed changes, alternatives and/or substitutions may be required to undergo a review by other end users, e.g. a peer or other review and/or the USPTO or other duly authorized body, prior to inclusion in the approved or appropriate database. In the case that such a system is a private system, e.g., owned and operated by IBM, then the system may be configured such rules and regulations may be imposed only by authorized IBM personnel. Regardless, once one or more diagrams, and their associated short and/or long descriptions or other notes are made available in the database, end users may then make use of any such diagrams, figures, notes and/or short or long descriptions. Such use may be with or without modifications by the end user, if permitted, and/or may require some level of review or approval, e.g., by a USPTO employee.

In cases where end users subsequently make changes to diagrams, notes, figure numbers, and/or short or long descriptions and/or to the figures themselves, such end users may or may not be required or have the option to include additional information regarding such changes. For example, end users may indicate the importance, relevance or necessity of such changes. For example, a given modification or change may be cosmetic or it may be material. Changes may be optional or mandatory. End users may enter such absolute relevancy criteria, e.g., mandatory and/or end users may enter relative rankings, e.g., the end user might indicate a given change is, cosmetic, desirable, material, or mandatory, or may use any applicable or useful rankings, e.g., a numeric or other ranking or weighting scale.

In certain embodiments, relevancy may be determined, in whole or in part, based upon automated means. In addition to the novel relevancy ranking methods disclosed herein, other methods to determine relevancy between and among documents and/or websites are well known within the prior art, including, for example, the methods discussed in the book entitled “Text Databases and Document Management: Theory and Practice, by Amita Goyal Chin, which is incorporated by reference.

In another embodiment, relevancy may be determined by asking end users to respond to one or more survey questions.

In certain embodiments, any and/or all such changes, modifications and/or alternatives may be tracked using a change tracking program, which may further store before and after images of any such figures, diagrams, notes, figure numbers, etc., so that a record of such changes, and the end user(s) that made such changes are known and an audit trail may therefore be provided. Such audit trail may be stored in a database designed for such purposes, and/or the system may attach one or more notes in succession to provide such information/audit trail.

In another embodiment, when inserting or referencing a figure or figure number, the disclosed system may bring up a list of figures by number and/or short or long description to permit the end user to determine which figure should be inserted and/or referenced. In such cases, the system may insert the figure number and/or short and/or long description. In certain embodiments, if the end user or another person modifies the database of figures, and/or their descriptions, such modifications may be automatically updated throughout the end user's patent application. Automatic updates may be partially or fully restricted based upon any applicable set of rules or regulations provided by the system and/or, if available, the end user. For example, the system may be designed such that, once a patent application has been filed, subsequent updates to the figures and/or numbers may not be automatically made in such application. In any case, when or if a change is made to the figure database end users that have previously referenced or used such figures or descriptions or other information may be notified. Such notice may be made only when or if the end user reopens an application for subsequent review or modification and/or such notice(s) may be made at any time using any applicable means. For example, end users may be sent an alert via email or other mans. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Regardless of the method of notification, when or if an end user reopens an application, the system may prompt the end user to determine if the end user wants to accept, modify and/or incorporate one or more of any or all such modifications, changes or updates to the figures, figure numbers and/or any short or long descriptions and/or notes. End users may be presented with a list of any such modifications, changes or updates and/or notes. End users may choose to apply any one or more or all of any such modifications, changes or updates. For example, end users may be presented with a list of any or all such changes. Such list may be sorted via any applicable means, including, for example, by relevancy or frequency of use and/or by the extent or date of the change. In certain embodiments, such listings may include additional information regarding the nature of the change and/or the importance of the change and/or may display other useful information. For example, in the cases where the end user that made such changes provided relevancy information, such information may be displayed. For example, if an end user indicated that such a change is mandatory and/or provided other information, e.g., via a note, such information may appear along with the listing, which additional information may assist an end user or system in determining whether or not to make use of part or all of any such changes and/or determine if such change(s) require further review or approval prior to any such application or use. Such information may also be used to determine the order such change listing are displayed or sorted. For example, changes that have been entered as “mandatory” may appear at the top of any such list, while those that were flagged as “cosmetic” may appear at the bottom of such listing. In another embodiment, certain changes, e.g., those flagged as mandatory, may be automatically updated, with or without the end users, knowledge or involvement or acknowledgement. In yet another embodiment, changes flagged as mandatory may, for example, receive priority review or approval.

In certain embodiments, if an end user modifies or submits notes, and/or alternatives or other information regarding a figure, document or other information that was created by or modified by other end users, such other end users may be notified of any or all such modifications, proposed or pending or approved, and/or notes or alternatives or other information. Such notification may be accomplished by any applicable means, including, for example, using the alert system described above.

In another embodiment, as the end user inserts a note, diagram or figure number, the system may also create a listing viewable by the end user and/or provide another means to permit the end user to determine or review all instances or uses of the same note, figure or diagram or figure number. In this way, end users can quickly review a given document or patent to read descriptions or other information and/or review the context of such use. Access to or tools to aid an end user in this regard can be accomplished via any applicable means, for example, the end user may be permitted to right click on a figure or figure number and the system might display a list of locations or hyperlinks to all uses within the document, and/or other relevant documents of the end user and/or to all known uses and/or citations/references. The end user may skip from entry to entry, or select from a list of entries to be immediately redirected to such selected entry. In certain embodiments, such information may be presented in a visual form such as in a pictorial or other diagram, e.g., a map view. Such maps and/or visual presentation may be accomplished via any applicable means, including methods disclosed in US patent application No. ______ (Attorney docket No. 3303104) entitled “Self-Teaching Thesaurus,” filed Apr. 6, 2007

In certain embodiments, lists may be presented in the form of one or more hyperlinks. For example, a list of referenced figures may be displayed sorted in order of figure numbers or other preferences. End users may then view the figures and/or any supporting materials, e.g., notes and/or other documents by clicking on or otherwise indicating or requesting or activating such one or more hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of which is hereby incorporated by reference.

In certain embodiments, the system can also analyze a figure created by an end user and create notes to indicate where the figure does not enable the specification of the application. The system can also indicate areas of a figure that are problematic or unclear.

In some embodiments, a lexicon of image components can be created. The image components can have corresponding definitions that link them to words in the patent application via the patent drafting tool and lexicon plug in. A particular word in the lexicon can have specific images stored with it that can be embedded into a patent figure. Inclusion or creation of such lexicon may be accomplished by any applicable means. Methods to create a lexicon and/or map are disclosed in U.S. patent application Ser. Nos. 11/668,586 “Targeted Advertising Based on Invention Disclosures,” filed Jan. 30, 2007; 11/668,596, “Keyword Advertising in Invention Disclosure Documents,” filed Jan. 30, 2007; ______ (Attorney docket No. 3303103) “Merchant Tool for Embedding Advertisement Hyperlinks to Words in a Database of Documents” filed Apr. 6, 2007; and ______ (Attorney docket No. 3303104) “Merchant Tool for Embedding Advertisement Hyperlinks to Words in a Database of Documents,” filed Apr. 6, 2007; each of which is hereby incorporated by reference.

In certain embodiments the drafting tool can be a plug in or add on module to a popular drafting tool such as Microsoft Visio.

In certain embodiments, the tool can analyze a drafted document and identify areas of the document that are not compliant with patent office rules. An AI system can generate a list of issues with a figure. It can be trained by having examiners review figures and providing comments into the system. In yet another embodiment, such analysis may be provided, in whole or in part, by one or more end users, e.g., a patent examiner. For example, end users may include notes or use any other applicable means to review and/or contest one or more figures, diagrams and/or documents or notes. Methods to provide end users with a means to contest such figures, diagrams and/or notes are disclosed in U.S. patent application Ser. Nos. 11/668,586 “Targeted Advertising Based on Invention Disclosures,” filed Jan. 30, 2007; 11/668,596, “Keyword Advertising in Invention Disclosure Documents,” filed Jan. 30, 2007; ______ (Attorney docket No. 3303103) “Merchant Tool for Embedding Advertisement Hyperlinks to Words in a Database of Documents” filed Apr. 6, 2007; and ______ (Attorney docket No. 3303104) “Merchant Tool for Embedding Advertisement Hyperlinks to Words in a Database of Documents,” filed Apr. 6, 2007; each of which is incorporated by reference above.

In another embodiment, the system can generate patent text based on the figure(s) that is/are loaded into a patent application drafting template where it can be modified by one or more end users and/or authorized end users. For example, an end user may create a patent application but refrain from creating a section referring to the diagrams used within the document. Such end user might add figures or figure numbers and/or hyperlinks, which refer to a database of existing, perhaps approved or standardized figures and their associated numbers, diagrams, images, and/or descriptions. At any time, and/or continuously, the system might add a “reference to the diagrams” section, and/or add the diagrams and figure numbers and/or an index or table of contents and/or list of one or more hyperlinks to said diagrams, figures, indices and/or table of contents, automatically. In such cases, the system could retrieve any or all of the relevant information via any applicable means, for example, by retrieving the figures, figure numbers and descriptions and inserting such information wherever appropriate within the document, e.g., patent application. Such insertions may be done with or without end user knowledge, action or acknowledgement. In certain cases, such insertions of information may be done with or without using a method to highlight and/or track such changes, e.g., underlining or redlining such document changes, e.g., using a change tracking system or method, such as the change tracking feature offered by Microsoft's Word Processing application. In the cases where such changes are tracked, in whole or in part, the end user may then be permitted to review and either accept or reject such changes in whole or in part, which may be accomplished by accepting or rejecting individual changes and/or classes of changes, or types of changes, e.g., by priority type, and/or accept them and then subsequently modify the automated entries to suit their purpose.

In certain embodiments, the disclosed invention may be used by private entities, such as individual inventors, patent law firms, and/or private companies. In other embodiments, the disclosed invention may be a system provided by a third party as a service to one or more end users, including one or more private firms and/or may be provided by the USPTO or other governing body. In any such cases, the system may be designed to permit the creation and use of private figures, graphics, icons, and/or descriptions (i.e., short or long), and permit the use of notes to be attached to any of the forgoing. Such “private” information may be accessible only to those who have created such information and/or have been granted authorization to access such information. Such authorization may or may not permit such end user to submit new or changes to such information.

In another embodiment, the system may permit the use of any of the above-mentioned information by any end user and/or authorized end users. For example, a database of shared information may exist instead of or in addition to a private database of information. In the event a shared database is provided, such database or databases may be shared by any end user, and/or all or certain databases may have one or more restrictions on their use and/or they may require certain access authorizations. In certain embodiments, all or classes of users may submit new and/or modified graphics, icons, figures, descriptions, etc., which submissions may or may not require review prior to such submissions being made generally available, e.g., a patent examiner or other authorized person may need to review and approve any such submissions. In certain embodiments, once such information is made available in a shared database, those end users granted access to such database, which may include all or a subset of all end users, may then be permitted to use such information, for example, by incorporating such shared information within their patent application.

In certain embodiments, end users may then submit proposed changes to such shared information. Changes may be permitted directly by any or only certain classes or specific end users, and/or changes may not be made directly to any existing information, but rather such changes may be added by creating a new entry, or version of the initial entry. In this fashion, the system could maintain a historical record of any or all such changes, which may prove useful in controlling the use or application of any such changes in any existing or future draft or application and/or to prove the existence and/or timing of any such changes to any shared or public database or repository of such graphics, images, figures, diagrams, descriptions, etc.

In another embodiment, end users may opt to “undo” the acceptance of any changes to any figures, figure numbers, diagrams, notes, and/or descriptions. Such undo feature may permit an end user or authorized end user to undo changes submitted by the end user or by other end users to the shared or private database(s) or repositories and/or to any one or more patent applications that may have been manually or automatically updated to incorporate any such changes. By keeping track of changes made to the database, the type of change and/or the date, and/or purpose or relevancy of any such changes, end users may be afforded a great deal of flexibility when deciding which changes to accept, apply and/or undo. For example, if the system is implemented to automatically incorporate “mandatory” changes to any applications making use of a particular or group or all figures that have been modified or incorporated into any one or more documents or patent applications, and, subsequently, an error is found in a previously submitted, accepted and approved change, the system and or an end user or authorized end user, may then opt to undo such change from either the database or repository and/or “roll back” or undo such changes from any or all affected documents or applications. When such undo feature is utilized, owners of documents may be notified via an alert. Such changes may be automatically accomplished by changing the document back to reflect the information or descriptions in place just prior to such changes. In certain embodiments, such changes when inserted into one or more documents, may or may not require end user approval or knowledge or action or acknowledgment and/or such changes may or may not be made using change tracking features that permit the end user to review any such changes and/or accept or reject any such changes in whole or in part.

In yet another embodiment, end users may be required or may optionally view one or more advertisements before, during or after using the disclosed invention. Such action may cause the system to charge a lower or different or no fee for using the patent drafting tool or one or more of the disclosed inventions. Implementation of such advertising may be accomplished via any applicable means. For example, advertisers may rent, license, and/or pay a fee to insert a hyperlink or otherwise display one or more advertisements, before, during or after such application usage.

In certain embodiments, before displaying an advertisement and/or before presenting a list of words and/or documents, e.g., from a lexicon of words, and/or before or during or after use of any of the disclosed features or inventions herein, it may be desirable to ascertain certain additional information about such advertisement and/or request for information and/or use. In such cases, the system may determine that it is necessary, desirable or generally useful to present one or more survey questions to aid in determining which words, documents, or other information should be presented, and/or to determine which features of the disclosed invention should or should not be enabled and/or to determine which advertisement might yield generally better results, and/or which word or synonym is generally more relevant given the information known about the end user and/or collected by using and/or displaying and/or gathering results from one or more such survey questions. Based upon the end user's response the system might either provide limited or no access to the system, and/or the system may also provide an advertisement. Based upon the response to one or more questions, the system may present additional qualifying questions, i.e., additional questions to further narrow the search results and or the sort display results, and/or provide access and/or limited access for free and/or for a fee or a reduced fee or reduced or extended period of time. Exemplary methods to provide for survey questions and gathering of data are disclosed by applicants in U.S. Patent Application Nos. 60/774,177, entitled “Survey Based Qualification of Keyword Searches,” 11/278,123, also entitled “Survey Based Qualification of Keyword Searches” 11/562,738 “Survey Based Qualification of Keyword Searches” and 11/608,150, entitled “Map and Inventory Based On-Line Purchases” which applications are incorporated herein by this reference.

It will be understood that all embodiments herein which refer to a patent are equally applicable to a patent application, and vice versa, unless explicitly stated otherwise with respect to a particular embodiment. The references to a patent (or to a patent application) are for reasons of brevity only.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary programs include:

| 1. | Drafting Program |
|---|---|
| 2. | Document Filing Program |
| 3. | Certification Program |
| 4. | Billing Program |
| 5. | Alert Program |
| 6. | Figure Compliance Program |
| 7. | Advertising Program |
| 8. | Authorization Program |
| 9. | Change Tracking Program |
| 10. | Mapping Program |
| 11. | Contest Tracking Program |
| Exemplary database architectures include: | |
| Figure Database | |
| 1. | Figure ID |
| 2. | Figure Description |
| 3. | Figure or Attachment |
| 4. | Submitted By ID |
| 5. | Source ID |
| 6. | Editor Application ID |
| 7. | Document/Patent Application Where Used ID 1-N |

| | |
|---|---|
| a. | Hyperlinks 1-N |

| 8. | Notes 1-N |
|---|---|
| Document Database | |
| 1. | Document ID |

| | |
|---|---|
| a. | Document Description |
| b. | Document Owner ID |
| c. | Hyperliniks (e.g., document locations) 1-N |
| d. | Class 1-N |
| e. | Subclass 1-N |
| f. | Type 1-N |
| g. | Subtype 1-N |
| h. | Date/Time Stamps |

| | |
|---|---|
| 1. | Submitted/Found/Indexed On |
| 2. | Submitted/Found/Indexed By ID or Hyperlink |
| 3. | Revised On 1-N |
| 4. | Revised By 1-N |
| 5. | Before Image 1-N |
| 6. | After Image 1-N |

| | |
|---|---|
| i. | Notes 1-N |

| Template Database | |
|---|---|
| 1. | Template ID # |
| 2. | Narrative/Descriptions |

| | |
|---|---|
| a. | Short Description |
| b. | Long Description |

| | |
|---|---|
| 3. | Template Type |
| 4. | Template Class |
| 5. | Template Sub-class |
| 6. | Uses Rules 1-N |
| 7. | Limitation Rules 1-N |
| 8. | Template Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origen Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Templates |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Font Database | |
| 1. | Font ID # |
| 2. | Narrative/Descriptions |

| | |
|---|---|
| a. | Short Description |
| b. | Long Description |

| | |
|---|---|
| 3. | Font Type |
| 4. | Font Class |
| 5. | Font Sub-class |
| 6. | Uses Rules 1-N |
| 7. | Limitation Rules 1-N |
| 8. | Font Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origen Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Fonts |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Shape Database | |
| 1. | Shape ID # |
| 2. | Narrative/Descriptions |

| | |
|---|---|
| a. | Short Description |
| b. | Long Description |

| | |
|---|---|
| 3. | Shape Type |
| 4. | Shape Class |
| 5. | Shape Sub-class |
| 6. | Uses Rules 1-N |
| 7. | Limitation Rules 1-N |
| 8. | Shape Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origen Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Shapes |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Icon Database | |
| 1. | Icon ID # |
| 2. | Narrative/Descriptions |

| | |
|---|---|
| a. | Short Description |
| b. | Long Description |

| | |
|---|---|
| 3. | Icon Type |
| 4. | Icon Class |
| 5. | Icon Sub-class |
| 6. | Uses Rules 1-N |
| 7. | Limitation Rules 1-N |
| 8. | Icon Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origen Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Icons |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Image Database | |
| 1. | Image ID # |
| 2. | Narrative/Descriptions |

| | |
|---|---|
| a. | Short Description |
| b. | Long Description |

| | |
|---|---|
| 3. | Image Type |
| 4. | Image Class |
| 5. | Image Sub-class |
| 6. | Uses Rules 1-N |
| 7. | Limitation Rules 1-N |
| 8. | Image Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origen Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Images |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Component Database | |
| 1. | Component ID # |
| 2. | Narrative/Descriptions |

| | |
|---|---|
| a. | Short Description |
| b. | Long Description |

| | |
|---|---|
| 3. | Component Type |
| 4. | Component Class |
| 5. | Component Sub-class |
| 6. | Uses Rules 1-N |
| 7. | Limitation Rules 1-N |
| 8. | Template Contents |

| | |
|---|---|
| a. | Free Form Text |
| b. | FIGS. 1-N |
| c. | Notes 1-N |

| | |
|---|---|
| 9. | Fees for Use Rules |

| | |
|---|---|
| a. | Rule ID 1-N |

| | |
|---|---|
| 10. | Fee sharing rules |

| | |
|---|---|
| a. | Rule ID 1-N |

| | |
|---|---|
| 11. | Origin Information |

| | |
|---|---|
| a. | Submitted by ID |
| b. | Submitted on date/time |
| c. | Notes 1-N |

| | |
|---|---|
| 12. | Change Tacking ID - 1-N |
| 13. | Transaction Database ID 1-N |
| 14. | Review Information |

| | |
|---|---|
| a. | Reviewed By ID 1-N |
| b. | Reviewed On Date/Time 1-N |
| c. | Results Notes 1-N |
| d. | Rejected By ID 1-N |
| e. | Rejected On Date/Time 1-N |
| f. | Rejected Notes 1-N |
| g. | Accepted By ID 1-N |
| h. | Accepted On Date/Time 1-N |
| i. | Accepted Notes 1-N |

| | |
|---|---|
| 15. | Relevant/Alternative/Substitute Components |

| | |
|---|---|
| a. | Alternative Template ID 1-N |
| b. | Relevancy or Rank or Score 1-N |
| c. | Notes - 1-N |

| | |
|---|---|
| 16. | Dispute/Contest Tracking |

| | |
|---|---|
| a. | Contest Case ID # 1-N |
| b. | Notes 1-N |

| 17. | Security/Authorized Users ID 1-N (or class of users) |
|---|---|
| Type Database Definitions | |
| 1. | Type ID |
| 2. | Description |
| 3. | Includes Classes ID 1-N |
| 4. | Rules 1-N |
| 5. | Notes 1-N |
| 6. | Type ID |
| 7. | Description |
| 8. | Rules 1-N |
| 9. | Notes 1-N |
| Class Database Definitions | |
| 1. | Class ID |
| 2. | Description |
| 3. | Includes Sub-Classes ID 1-N |
| 4. | Rules 1-N |
| 5. | Notes 1-N |
| Sub-class Database Definitions | |
| 1. | Sub-Class ID |
| 2. | Description |
| 3. | Rules 1-N |
| 4. | Notes 1-N |
| Filed Document Lexicon | |
| 1. | Lexicon Database ID/Name/Location |
| 2. | Lexicon (e.g., Figure, Word, Document or Image) ID # 1-N |
| 3. | Submitted by ID # 1-N |
| 4. | Examiner ID # 1-N |
| 5. | Attorney ID # 1-N |
| 6. | Description |
| 7. | Notes 1-N |
| 8. | Lexicon Image 1-N |
| 9. | Date/Time Submitted |
| 10. | Notes 1-N |
| Contest Definition Queue | |
| 1. | Contest Case ID # |
| 2. | Queue ID # |
| 3. | Queue Position # |
| 4. | Submitted by ID # 1-N |
| 5. | Examiner ID # 1-N |
| 6. | Attorney ID # 1-N |
| 7. | Description |
| 8. | Figure, Word, Notes or Documents ID # 1-N |
| 9. | Reasons for case |
| 10. | Proposed solutions |
| 11. | Notes 1-N |
| 12. | Date/Time Stamps |

| | |
|---|---|
| a. | Submitted on date/time |
| b. | Expected next review date/time |

| Compliance Rules Database | |
|---|---|
| 1. | Rule ID |
| 2. | Description |
| 3. | Rules 1-N |
| Change Tracking Database | |
| 1. | Change Tracking ID |
| 2. | Figure, Document, Note ID |
| 3. | Change Type (e.g., Add, change, delete) |
| 4. | Change Description |
| 5. | Date/Time |
| 6. | User ID |
| 7. | Before Image |
| 8. | After Image |
| 9. | Relevancy or score |
| 10. | Notes 1-N |
| Advertiser or Notes Owner Database | |
| 1. | Advertiser/Owner ID |
| 2. | Advertiser/Owner Name |
| 3. | Security Profile |
| 4. | Classes of Trade 1-N |
| 5. | Advertiser/Owner Financial Information |

| | |
|---|---|
| a. | Billing Method ID |
| b. | Credit Card Information |

| | |
|---|---|
| 1. | Preferred Card Number |
| 2. | Preferred Card Holder |
| 3. | Preferred Card Type |
| 4. | Name |
| 5. | Expiration Date |
| 6. | Security Code |

| | |
|---|---|
| c. | Additional Cards 1-N |

| | |
|---|---|
| 1. | Card Number |
| 2. | Card Holder (e.g., Bank Name) |
| 3. | Card Type (e.g., Visa) |
| 4. | Name |
| 5. | Expiration Date |
| 6. | Security Code |

| | |
|---|---|
| 6. | Advertiser/Note Owner Mailing Address |
| 7. | Advertiser/Note Owner Rules Database |

| | |
|---|---|
| a. | Rule ID 1-N |

| | |
|---|---|
| 1. | Word(s)/Documents Applied To 1-N |

| | |
|---|---|
| a. | Rule Description |
| b. | Rules 1-N |
| c. | Billing Terms and Conditions ID 1-N |

| | |
|---|---|
| 8. | Advertiser/Note Owner Attorney of Record |

| | |
|---|---|
| a. | Attorney ID 1-N |

| 9. | Advertiser/Note Owner Qualifications 1-N |
|---|---|
| 10. | Notes 1-N |
| Advertiser/Note Owner Qualifications Database | |
| 1. | Qualification ID |
| 2. | Description |
| 3. | Qualification Type |
| 4. | Years Experience |
| 5. | Fields of Use Applicable 1-N |
| 6. | Notes 1-N |
| Attorney Database | |
| 1. | Attorney ID |
| 2. | Name |
| 3. | Security Profile |
| 4. | Address |
| 5. | Description |
| 6. | Qualifications 1-N |
| 7. | Notes 1-N |
| Billing Terms and Conditions Database | |
| 1. | Billing Method ID |
| 2. | Billing Type |
| 3. | Description |
| 4. | Billing Frequency |
| 5. | Due by # days |
| 6. | Late by # days |
| 7. | Interest Rate Fixed |
| 8. | Interest Rate Variable |
| 9. | Interest Accrues after days |
| 10. | Notes 1-N |
| Accounts Receivable Database | |
| 1. | Advertiser/Note Owner ID |
| Total Amount Owed | |
| 2. | Transaction Detail Records 1-N |

| | |
|---|---|
| a. | Date of Transaction |
| b. | Type |
| c. | Advertisement ID |
| d. | Word ID |
| e. | Hyperlinks 1-N |
| f. | Amount per impression or click through |

| | |
|---|---|
| 3. | Notes 1-N |

| Search Database | |
|---|---|
| 1. | Document ID |
| 2. | Document Location/Hyperlink |
| 3. | Notes 1-N |
| Transaction Database | |
| 1. | Transaction ID |
| 2. | Description |
| 3. | Date/Time |
| 4. | Type |
| 5. | Advertiser/Note Owner ID |
| 6. | Advertisement/Note Owner Rules Used 1-N |
| 7. | Billing T&C's 1-N |
| 8. | Billing Method ID |
| 9. | Transaction Amount |
| 10. | Results 1-N |

| | |
|---|---|
| a. | Note Added, Changed, Deleted, and/or Accessed |
| b. | Hyperlink Clicked |
| c. | Sub-Hyperlinks Clicked 1-N |

| | |
|---|---|
| 1. | Advertisement/Note and/or Webpage) Displayed 1-N |
| 2. | Click Through y/n |
| 3. | Duration of view |
| 4. | Conversion y/n |
| 5. | Conversion dollar amount |

| 11. | Notes 1-N |
|---|---|
| Advertisement Database | |
| 1. | Advertisement ID |
| 2. | Advertiser ID |
| 3. | Description |
| 4. | Words 1-N |
| 5. | Documents 1-N |
| 6. | Hyperlinks 1-N |
| 7. | Advertising Content File 1-N |
| 8. | Notes ID 1-N |
| Document Class Database | |
| 1. | Class ID |
| 2. | Description |
| 3. | Notes 1-N |
| Document Sub Class Database | |
| 1. | Subclass ID |
| 2. | Description |
| 3. | Notes 1-N |
| Document Type Database | |
| 1. | Type ID |
| 2. | Description |
| 3. | Notes 1-N |
| Document Sub Type Database | |
| 1. | Subtype ID |
| 2. | Description |
| 3. | Notes 1-N |
| Group Database | |
| 1. | Group ID |
| 2. | Description |
| 3. | Notes 1-N |
| Advertisement Type Database | |
| 1. | Type ID |
| 2. | Description |
| 3. | Notes 1-N |
| Word Count Database | |
| 1. | Word ID |
| 2. | Number of Occurrences |
| 3. | Hyperlinks 1-N |
| 4. | Notes 1-N |
| Survey Database | |
| 1. | Survey ID |
| 2. | Survey Description |
| 3. | Advertiser ID |
| 4. | Survey Question ID 1-N |

| | |
|---|---|
| a. | Question |
| b. | Answer Options 1-N |

| 5. | Notes 1-N |
|---|---|
| Results Database | |
| 1. | Result ID |
| 2. | End User ID |
| 3. | Survey Questions 1-N |
| 4. | Survey Answers 1-N |
| 5. | Date/Time Stamp |
| 6. | Narrative or Text Responses 1-N |
| 7. | Notes 1-N |
| Rules Database | |
| 1. | Rule ID |
| 2. | Rule Description |
| 3. | Rules 1-N |
| Notes Database | |
| 1. | Note ID |

| | |
|---|---|
| a. | Hyperlinks 1-N |
| b. | Note Description Short |
| c. | Note Description Long |
| d. | Note Group ID |
| e. | Note Class ID |
| f. | Note Subclass ID |
| g. | Note and/or Note Attachments 1-N |

| | |
|---|---|
| 1. | Owner/Submitted By ID |
| 2. | Original Submission Date/Time |

| | |
|---|---|
| 2. | Modifications 1-N |

| | |
|---|---|
| a. | Owner/Submitted By ID |
| b. | Modification Submission Date |
| c. | Short Description |
| d. | Long Description |

| | |
|---|---|
| 1. | Owner/Submitted By ID |
| 2. | Original Submission Date/Time |
| 3. | Hyperlinks 1-N |
| 4. | Change Image 1-N |

| | |
|---|---|
| a. | Before Change |
| b. | After Change |

| Hyperlink Database | |
|---|---|
| 1. | Hyperlink ID |
| 2. | Hyperlink |
| 3. | Description |
| 4. | Owner ID |
| 5. | Advertiser ID |
| 6. | Notes 1-N |
| User Database | |
| 1. | User ID |
| 2. | Name |
| 3. | Security Profile |
| 4. | Account Type |
| 5. | Description |
| 6. | Terms and Conditions ID |
| 7. | Text |
| 8. | Notes 1-N |
| Document Group Database | |
| 1. | Group ID |
| 2. | Description |
| 3. | Includes Sub-Groups/Sub-Class IDs 1-n |
| 4. | Notes 1-N |
| Document Class | |
| 1. | Class ID |
| 2. | Description |
| 3. | Includes Sub-Class IDs 1-N |
| 4. | Notes 1-N |
| Document Sub Class | |
| 1. | Subclass ID |
| 2. | Description |
| 3. | Notes 1-N |
| Note Class | |
| 1. | Note Class ID |
| 2. | Description |
| 3. | Includes Sub-Class IDs 1-N |
| 4. | Notes 1-N |
| Note Subclass | |
| 1. | Note Subclass ID |
| 2. | Description |
| 3. | Notes 1-N |
| Nick Name Database | |
| 1. | Nick Name ID |
| 2. | Nick Name (Short Description) |
| 3. | Nick Name (Long Description) |
| 4. | Patent or Document Number |
| 5. | Notes 1-N |
| Patent Application or Document ID Database | |
| 1. | Patent or Document ID # |
| 2. | Hyperlinks 1-N (e.g., Link to that patent on different websites) |
| 3. | Notes 1-N |
| Alert Event Rules Database | |
| 1. | Alert Event Rule ID |
| 2. | Alert Event Description |
| 3. | Alert Event Rules 1-N |

| | |
|---|---|
| a. | Event Condition |
| b. | Alert Recipient ID 1-N |

| | |
|---|---|
| 1. | Alert Method 1-N |

| | |
|---|---|
| c. | Alert Database ID 1-N |

| 4. | Notes 1-N |
|---|---|
| Alert Database | |
| 1. | Alert Database ID |
| 2. | Alert Contents, one or more of: |

| | |
|---|---|
| a. | Text |
| b. | Variable Data |
| c. | Executable |

| 3. | Notes 1-N |
|---|---|
| Alert Methods Database | |
| 1. | Alert Method ID |
| 2. | Method Type |
| 3. | Delivery Method (cell phone, pager, e-mail, PDA, database, |
| | executable, etc.) |
| 4. | Notes 1-N |
| Alert Recipient Database | |
| 1. | Alert Recipient ID (e.g., end user ID) |
| 2. | Description |
| 3. | Alert Method Preferences ID 1-N |
| 4. | Notes 1-N |

It will be appreciated that the various software and hardware components described above will be configured to perform a variety of functions and methods. Listed below are some exemplary methods that might be performed by the systems as described herein:

Create figure

| | |
|---|---|
| 1. | Receive a request to create a figure including class and subclass |
| 2. | Retrieve and Output figure templates |
| 3. | Receive figure data |

Analyze figure and generate omission suggestions

| | |
|---|---|
| 1. | Retrieve figure data |
| 2. | Analyze data and determine if omissions exist |
| 3. | Create omission suggestions |
| 4. | Output omission suggestions |

Create lexicon of image components

| | |
|---|---|
| 1. | Receive request to create image component |
| 2. | Output image component form |
| 3. | Receive image data |
| 4. | Create image component from image data |
| 5. | Store image component in lexicon |

Draft Figure

| | |
|---|---|
| 1. | Receive patent data |
| 2. | Determine figure description data from patent data |
| 3. | Generate image from figure description data |
| 4. | Output image |

Attach Figure to Document

| | |
|---|---|
| 1. | Receive figure data |
| 2. | Receive request to attach figure data to lexicon or patent data |
| 3. | Output lexicon form or patent data |
| 4. | Receive indication of attachment |
| 5. | Attach figure data to lexicon or patent data |

File Document

| | |
|---|---|
| 1. | Receive patent data |
| 2. | Receive/Generate figure data |
| 3. | Attach figure data to patent data |
| 4. | Output combined data for approval |
| 5. | Receive approval for combined data |
| 6. | File combined data |

Submit figure, template or component for certification

| | |
|---|---|
| 1. | Receive a request to submit figure data as a lexicon component |
| 2. | Output lexicon component form |
| 3. | Receive figure data |
| 4. | Store data and mark record as “uncertified” |

Certify figure or component

| | |
|---|---|
| 1. | Receive certifier login |
| 2. | Retrieve and output figure data |
| 3. | Receive figure data certification |
| 4. | Store figure data in lexicon |
| 5. | Mark figure data record as “certified” |

Create Figure Numbers

| | |
|---|---|
| 1. | Receive figure data |
| 2. | Generate numbers for figure data |
| 3. | Store figure data with numbers |

Include Figure Numbers in Application

| | |
|---|---|
| 1. | Retrieve patent application data |
| 2. | Retrieve figure data including numbers |
| 3. | Generate numbers for patent application data based on figure data |
| | including numbers |

Make Changes to Figures and Provide Notes

| | |
|---|---|
| 1. | Receive a request to alter figure data |
| 2. | Output figure for alteration |
| 3. | Receive figure alteration data |
| 4. | Store figure alteration data with figure |

Alert User When Figure is Updated

| | |
|---|---|
| 1. | Receive figure alterations |
| 2. | Determine users to alert |
| 3. | Alert users that figure has been altered |

Link Figures/Components to Lexicon Definitions

| | |
|---|---|
| 1. | Receive figure data, including class, subclass and definition |
| 2. | Determine like definitions in lexicon |
| 3. | Link figure to lexicon definition |

Determine if Figure is Compliant

| | |
|---|---|
| 1. | Receive figure data |
| 2. | Apply compliance rules to figure data |
| 3. | Determine if figure data complies to rules |
| 4. | Mark figure data record as “compliant” or “not compliant” |

Notify User if Figure is Not Compliant

| | |
|---|---|
| 1. | Retrieve non compliant records |
| 2. | Determine appropriate users |
| 3. | Alert users that figure is not compliant |

Generate Patent Text Based on Figures

| | |
|---|---|
| 1. | Receive figure data |
| 2. | Generate patent text based on figure data |
| 3. | Store patent text with figure data |

Initial Database Loading

| | |
|---|---|
| 1. | Create/Load Database(s) |
| 2. | Import Figures, Words, Definitions, Synonyms and Antonyms, |
| | hyperlinks, etc. from existing database sources (as appropriate/e.g., |
| | one time, and/or from time-to-time) |
| 3. | Update Database(s) |

Primary Figure Drafting Tool/Application

| | |
|---|---|
| 1. | Load Database(s) |
| 2. | Display primary GUI |
| 3. | Receive activity indication/request from end user |
| 4. | Determine if one or more subroutines should be executed |
| 5. | Execute one or more of the following subroutines as applicable/ |
| | necessary/desired |
| 6. | Update database(s) |

End User Preferences Application

| 1. | Load Databases | |
|---|---|---|
| 2. | Present Preferences GUI if required | |
| 3. | Receive End User Preferences/Feedback/Usage Tracking | |
| | Information, including: | |
| | a. | Filter Criteria or Rules |
| | b. | Sort Criteria or Rules |
| | c. | Relevancy Information |
| | d. | Weighting Factors, Criteria or Rules |
| | e. | Security Preferences |
| | f. | Feedback/Tracking Preferences |
| | g. | Notes |
| | h. | Usage habits/patterns |
| | i. | Display preferences |

Security Application

| | |
|---|---|
| 1. | Load Database(s) |
| 2. | Determine if requested action and/or end user is permitted |
| 3. | If not, notify application and/or end user |
| 4. | If yes, permit requested step and/or loading of application or other |
| | authorized action(s) |
| 5. | Update Database(s) |

Opt In/Sign Up Application

| | |
|---|---|
| 1. | Load Databases |
| 2. | Receiving Indication of new user sign up |
| 3. | Record any and all or available information regarding one or more |
| | patent applicant's, end users, examiners, attorneys and/or third parties |
| 4. | Update databases |

End User Preferences Application

| 1. | Load Databases | |
|---|---|---|
| 2. | Present Preferences GUI if required | |
| 3. | Receive End User Preferences/Feedback/Usage Tracking | |
| | Information, including: | |
| | a. | Filter Criteria or Rules |
| | b. | Sort Criteria or Rules |
| | c. | Relevancy Information |
| | d. | Weighting Factors, Criteria or Rules |
| | e. | Security Preferences |
| | f. | Feedback/Tracking Preferences |
| | g. | Notes |
| | h. | Usage habits/patterns |
| | i. | Display preferences |

Figure Creation/Modification Application

| 1. | Load Database(s) | |
|---|---|---|
| 2. | Display Figure Drafting/Revision GUI | |
| 3. | If requested, display one or more of: | |
| | a. | Templates |
| | b. | Icons |
| | c. | Fonts |
| | d. | Shapes |
| | e. | Images |
| | f. | Components |
| | g. | Drawing Tools |
| | h. | Import Options |
| | i. | Documents |
| | j. | Words |
| | k. | And/or maps |
| 4. | Capture “Before Images” of all figures, images, data, etc., and | |
| | optionally encrypt and date stamp such image(s) | |
| 5. | Receive input from user to add/modify/delete figure | |
| 6. | Create Figures, Hyperlinks, Indices, Table of Contents, Notes, | |
| | etc. and | |
| 7. | If applicable | |
| | a. | Create/Suggest Figure Number(s) |
| | b. | Insert or associate Figure Number(s) with Figures |
| | c. | Review Figures, etc. for errors and/or omissions |
| | d. | Notify end user of errors and/or omissions |
| | e. | Receive corrections to errors and/or omissions |
| | f. | Repeat process until no more errors or omissions, and |
| | g. | If applicable |

| | |
|---|---|
| 1. | Submit Figures etc. into one or more authorization and/or |
| | review queues |
| 2. | If Figures, etc., fail or pass such review process, notify end |
| | user |
| 3. | End user makes corrections as applicable/necessary and |
| | resubmits to authorization/review |
| 4. | Receive authorization/certifications as applicable and/or |
| | required to accept such add/modify/delete any one or more |
| | of: |

| | |
|---|---|
| a. | Figures |
| b. | Templates |
| c. | Icons |
| d. | Fonts |
| e. | Shapes |
| f. | Images |
| g. | Components |
| h. | Drawing Tools |
| i. | Import Options |
| j. | Documents |
| k. | Words |
| l. | And/or maps |

| | |
|---|---|
| 5. | Receive relevancy score(s) and/or mapping information |
| | and/or contested information |
| 6. | Upon receipt of authorization/certification or other |
| | approval processes, update as necessary: |

| | |
|---|---|
| a. | Figures, etc. |
| b. | Lexicon Definitions/Database |
| c. | Documents |

| | |
|---|---|
| 7. | Generate Patent Text, Documents, Figures, hyperlinks, |
| | Advertisements |
| 8. | Capture “After Images” of all figures, images, data, etc., |
| | and optionally encrypt and date stamp such image(s). |
| 9. | File Applications/Documents/Patents/Figures, etc. |

| | |
|---|---|
| 8. | Update Database(s) |

Figure Use/Insertion

| | |
|---|---|
| 1. | Load Database(s) |
| 2. | Receive one or more requests to search or display one or more: |

| | |
|---|---|
| 1. | Figures |
| 2. | Templates |
| 3. | Icons |
| 4. | Fonts |
| 5. | Shapes |
| 6. | Images |
| 7. | Components |
| 8. | Drawing Tools |
| 9. | Import Options |
| 10. | Documents |
| 11. | Words |
| 12. | And/or maps |

| | |
|---|---|
| 3. | Retrieve relevant |

| | |
|---|---|
| 1. | Figures |
| 2. | Templates |
| 3. | Icons |
| 4. | Fonts |
| 5. | Shapes |
| 6. | Images |
| 7. | Components |
| 8. | Drawing Tools |
| 9. | Import Options |
| 10. | Documents |
| 11. | Words |
| 12. | And/or maps |

| | |
|---|---|
| 4. | Display results and, if applicable, other relevant materials |
| 5. | Permit user to copy/paste or insert or otherwise associate any one or |
| | more such |

| | |
|---|---|
| 1. | Figures |
| 2. | Templates |
| 3. | Icons |
| 4. | Fonts |
| 5. | Shapes |
| 6. | Images |
| 7. | Components |
| 8. | Drawing Tools |
| 9. | Import Options |
| 10. | Documents |
| 11. | Words |
| 12. | And/or maps |
| 13. | into one or more patent applications or other document(s) |

| | |
|---|---|
| 6. | Permit end user to submit additions/changes or modifications to such |

| | |
|---|---|
| 1. | Figure(s) |
| 2. | Templates |
| 3. | Icons |
| 4. | Fonts |
| 5. | Shapes |
| 6. | Images |
| 7. | Components |
| 8. | Maps |
| 9. | as applicable |

| | |
|---|---|
| 7. | Update Database(s) |

Advertisement Creation Application

| | |
|---|---|
| 1. | Load Database(s) |
| 2. | Display advertising creation/modification GUI |
| 3. | Receive request to add/change/delete one or more advertisements |
| 4. | Receive advertisement hyperlink contents and associate with one or |
| | more |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |

| | |
|---|---|
| 5. | Determine if such |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |

| | |
|---|---|
| b. | have pre-existing hyperlinks by current or third party end user or |
| | otherwise |

| | |
|---|---|
| 6. | If not, determine price to associate hyperlink as applicable |
| 7. | If one or more similar hyperlinks already exist, execute hyperlink bid |
| | pricing application |
| 8. | If approved and priced, insert or otherwise associate said hyperlink |
| | with said one or more |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |

| | |
|---|---|
| 9. | Update Database(s) |

Hyperlink Pricing Program

| | |
|---|---|
| 1. | Load Database(s) |
| 2. | Receive pricing request |
| 3. | Determine if more than one user wishes a hyperlink to the same or |
| | similar |

| | |
|---|---|
| 1. | Patents |
| 2. | Figure(s) |
| 3. | Templates |
| 4. | Icons |
| 5. | Fonts |
| 6. | Shapes |
| 7. | Images |
| 8. | Components |
| 9. | Maps |

| | |
|---|---|
| 4. | Determine pricing and/or auction hyperlink, or, if applicable, position |
| | in list of two or more hyperlinks |
| 5. | Notify affected parties, e.g., via an alert |
| 6. | Receive indication from one or more users as to willingness to |
| | pay and price points |
| 7. | Continue process until pricing is determined |
| 8. | Receive authorizing for final pricing from affected parties, including |
| | end users |
| 9. | Update Database(s) |

Advertisement Viewing/Use Application

| | |
|---|---|
| 1. | Load Database(s) |
| 2. | Receive request to display or access advertisement, e.g., user clicks |
| | hyperlink or right clicks word |
| 3. | Determine if additional browser page or popup or other display |
| | method is to be used |
| 4. | Display Advertisement, e.g., load and display attached movie file |
| 5. | Determine if survey should be presented |
| 6. | Present survey |
| 7. | Determine if secondary or different advertisement is to be displayed |
| 8. | Display advertisement |
| 9. | Collect usage information, e.g., impressions for billing purposes |
| 10. | Update Database(s) |

Word Definition/Synonym/Antonym/Figure/Document Lookup Tool

| | |
|---|---|
| 1. | Load Database(s) |
| 2. | Receive request from drafting or third party display tool for |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |
| 10. | Documents |
| 11. | Notes |

| | |
|---|---|
| b. | (and/or any one or any combination or all of the forgoing) |

| | |
|---|---|
| 3. | Determine relevancy information |
| 4. | Retrieve requested information, using relevancy information if |
| | applicable/available |
| 5. | Determine if additional browser page or popup or other display |
| | method is to be used (e.g., interstitial popup window) |
| 6. | Determine if application and/or end user has requested filter and/or |
| | sort and/or relevancy options |
| 7. | Display Requested Information (using filter, sort and/or relevancy |
| | information and/or filter criteria if applicable//available) |
| 8. | Update Database(s) |

Document/Figure Submission/Filing Application

| | |
|---|---|
| 1. | Load Database(s) |
| 2. | Receive request to submit document or figures, with figure numbers, |
| | words, synonyms, antonyms, notes and/or related documents to |
| | database, repository or processing agency, e.g., USPTO |
| 3. | Capture image of all relevant materials, including then current |
| | figures, definitions, along with Time/Date stamp information |
| 4. | If desired, encrypt any or all output materials, e.g., patent application, |
| | figures, definitions, words, synonyms, antonyms, and/or related |
| | documents, notes and/or supporting materials to prevent or otherwise |
| | control subsequent access and/or modifications |
| 5. | Update Database(s) |

Mapping Program

| | |
|---|---|
| 1. | Load Databases |
| 2. | Receive indication that one or more w |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |
| 10. | Documents |
| 11. | Notes |
| 12. | have been added or changed or removed from one or more |
| | databases |

| | |
|---|---|
| 3. | Receive or determine relevancy information |
| 4. | Determine mapping relationships among any one or more of the |
| | forgoing |
| 5. | Monitor usage and feedback of/on any one or more of the following, |
| | including: |

| | |
|---|---|
| 1. | Patents (disclosures, applications, publications, issued) |
| 2. | Figure(s) |
| 3. | Templates |
| 4. | Icons |
| 5. | Fonts |
| 6. | Shapes |
| 7. | Images |
| 8. | Components |
| 9. | Maps |
| 10. | Documents |
| 11. | Notes |
| 12. | and/or mapping usage |

| | |
|---|---|
| 6. | Receive feedback from end users and/or determine change in |
| | mapping relationships and/or relevancy |
| 7. | If desired or required, submit any such changes for review/approval |
| 8. | If approved, update mapping relationship data accordingly |
| 9. | Update Databases |

End User Contest Application

| 1. | Load Database(s) | |
|---|---|---|
| 2. | Receive Indication that one or more end users and/or third parties, | |
| | e.g., patent examiner, contests one or more figures, documents, | |
| | patents, word definitions, words, synonyms, antonyms, notes, and/or | |
| | other documents and/or supporting materials | |
| 3. | Determine relevancy/validity of the contest by any one or all of the | |
| | following if desired/applicable | |
| | a. | Solicit other end user/third party votes/scores/ranking |
| | b. | Use GA |
| | c. | Submission to authorized end user or third party |
| | d. | Preponderance of feedback |

| | |
|---|---|
| 4. | If contest is determined valid, accept requested changes |
| 5. | Otherwise reject requested changes |
| 6. | Update Database(s) |

Billing Program

| | |
|---|---|
| 1. | Load Database(s) |
| 2. | Receive indication that billing activity has occurred |
| 3. | Determine affected parties, e.g., payer and payee |
| 4. | Determine billing rules, terms and conditions |
| 5. | Determine billing amounts due |
| 6. | Create Invoice and A/P or A/R notices/entries |
| 7. | Send Invoices and notices |
| 8. | Update Databases |
| 9. | Await Payment |
| 10. | Receive payment indication |
| 11. | Apply payments |
| 12. | Notify A/P or A/R systems/and/or affected parties |
| 13. | Determine if payments are timely/sufficient |
| 14. | If not, execute collections program |
| 15. | Update Database(s) |

Collections Program

| 1. | Receive indication payments are late an/or insufficient | |
|---|---|---|
| 2. | Load Database(s) | |
| 3. | If applicable, execute one or more of the following steps: | |
| | a. | Send late notice |
| | b. | Send insufficient payment or funds notice |
| | c. | Limit or prevent further use until payment terms are partially or |
| | | fully satisfied, each according to billing terms and conditions |
| | | and/or rules |
| | d. | Collect funds due from primary and/or secondary credit cards on |
| | | file. |
| | e. | Notify affected parties |

| | |
|---|---|
| 4. | Update Database(s) |

Alerts Program

| | |
|---|---|
| 1. | Load Database(s) |
| 2. | Determine if Alert Event has occurred |
| 3. | Determine Alert Contents based upon alert rules |
| 4. | Determine Alert Recipients and Contents and Delivery Method(s) |
| 5. | Send Alert(s) |
| 6. | Update |

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet/ or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A patent figure drafting tool comprising:
a database comprising:
a plurality of drawings; and
metadata associated with each drawing, wherein the metadata identifies:
a source document for the drawing;
commentary regarding the drawing;
alternate versions of the drawing;
a user interface configured to allow users to:
browse the database;
select one or more drawings in the database; and
construct a patent figure using the one or more selected drawings; and
a numbering module configured to insert number identifiers in the drawings.

2. The patent figure drafting tool of claim 1 wherein the source document is a previously submitted patent application.

3. The patent figure drafting tool of claim 1 wherein the numbering module is configured to automatically insert number identifiers in the drawing.

4. The patent figure drafting tool of claim 1 wherein the metadata further comprises a description of the drawing sufficient for use in a patent application.

5. The patent figure drafting tool of claim 4 wherein the user interface is further configured to add the description of the drawing to a draft patent application.

6. The patent figure drafting tool of claim 5 wherein the numbering module is further configured to automatically insert number identifiers in the figure and insert appropriate numbers in to the description.

7. The patent figure drafting tool of claim 6 wherein the number identifiers are selected by the numbering module based on previous number identifiers that have already been included in the draft patent application.

8. The patent figure drafting tool of claim 7 wherein the numbering module ensures that number identifiers are not inappropriately duplicated in the draft patent application.

9. A method comprising:
providing a patent figure drafting tool, wherein the patent figure drafting tool comprises:
a database comprising:
a plurality of drawings; and
metadata associated with each drawing, wherein the metadata identifies:
a source document for the drawing;
commentary regarding the drawing;
alternate versions of the drawing;
a user interface configured to allow users to:
browse the database;
select one or more drawings in the database; and
construct a patent figure using the one or more selected drawings; and
a numbering module configured to insert number identifiers in the drawings; and
determining a drawing to be inserted into a draft patent application;
determining which number identifiers are currently being used in the draft patent application; and
automatically numbering the drawing based on the determined number identifiers.

10. The method of claim 9 wherein automatically number the drawing comprises:
identifying the highest number previously used in the draft patent application; and
incrementing the highest number by a given number.

11. The method of claim 9 wherein the source document is a previously submitted patent application.

12. The method of claim 9 wherein the metadata further comprises a description of the drawing sufficient for use in a patent application.

13. The method of claim 12 further comprising automatically inserting the description of the determined drawing into the draft patent application.

14. The method of claim 13 further comprising automatically inserting the appropriate number identifiers in the description.

15. A method comprising:
accessing a patent figure drafting tool, wherein the patent figure drafting tool comprises:
a database comprising:
a plurality of drawings; and
metadata associated with each drawing, wherein the metadata identifies:
a source document for the drawing;
commentary regarding the drawing;
alternate versions of the drawing;
a user interface configured to allow users to:
browse the database;
select one or more drawings in the database; and
construct a patent figure using the one or more selected drawings; and
a numbering module configured to insert number identifiers in the drawings; and
providing a draft patent application; and
identifying a drawing to be inserted into a draft patent application;

16. The method of claim 15 wherein the source document is a previously submitted patent application.

17. The method of claim 15 wherein the number module is further configured to:
determine which number identifiers are currently being used in the draft patent application; and
automatically number the identified drawing based on the determined number identifiers.

18. The method of claim 17 further comprising:
reviewing the drawing after it has been inserted into the draft patent application; and
approving the number identifiers that were inserted into the drawing.

19. The method of claim 15 wherein the metadata further comprises a description of the drawing sufficient for use in a patent application.

20. The method of claim 19 wherein the user interface is further configured to automatically insert the description into the draft patent application; the method further comprising:
reviewing the inserted description; and
approving the inserting description.
